(19) United States
(12) Patent Application Publication
(10) Pub. No.: US 2005/0255283 A1
(43) Pub. Date: Nov. 17, 2005

(54) Optical recording medium

(75) Inventors: Takashi Yamada, Tokyo (JP); Tsuyoshi Komaki, Tokyo (JP); Tomoki Ushida, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/126,284

(22) Filed: May 11, 2005

(30) Foreign Application Priority Data
May 12, 2004 (JP) 2004-142079

(51) Int. Cl. B32B 3/02

(52) U.S. Cl. 428/64.4

(57) ABSTRACT

The optical recording medium includes a supporting substrate 2, an information layer 3 formed on a surface of the supporting substrate 2, a first resin layer 4 formed on the information layer 3 and having a thickness of 30 to 200 μm, a moisture-proof layer 5 formed on a rear surface of the supporting substrate 2, a second resin layer 6 formed on the moisture-proof layer 5 and having a thickness of 30 to 200 μm, and a label layer 7 formed on the second resin layer 6. The second resin layer 6 contains a filler and is formed by a screen printing method.

### BACKGROUND OF THE INVENTION

The present invention relates to an optical recording medium and more particularly, to an optical recording medium capable of preventing cost-up and minimizing warpage.

Optical recording media represented by Compact Disk (CD) or Digital Versatile Disk (DVD) have been widely used as a recording medium for recording digital data up to now. These optical recording media may be classified into reproduction-dedicated optical recording media such as CD-ROM or DVD-ROM in which data cannot be recorded or rewritten, recordable optical recording media such as CD-R or DVD-R in which data can be recorded but cannot be rewritten, and rewritable optical recording media such as CD- RW or DVD-RW in which data can be rewritten.

When data are reproduced from these optical recording media, a laser beam set for the reproduction is first irradiated on the optical recording medium. Since recording marks or pits formed in the optical recording medium is different from a region other than the recording marks or pits in terms of the reflectance of a laser beam, there occurs a strong or weak intensity in the reflected laser beam depending on the presence or absence of the recording marks or pits. The strong or weak intensity of the reflected laser beam is detected by a photodetector and converted into an electrical signal, thereby generating a reproduction signal for reproducing the data.

Accordingly, in order to correctly read data recorded in these optical recording media, it is necessary to make the laser beam reflected by the optical recording medium correctly returned to a light-receiving surface of the photodetector.

However, when a large warpage occurs in the optical recording medium due to a change in temperature while it is used, since the incident angle of the laser beam to the optical recording medium is varied, the reflected laser beam may not be correctly returned to the photodetector. Accordingly, in order to make it sure to reproduce desired data recorded in the optical recording medium, it is required to minimize the warpage of the optical recording medium.

Therefore, an optical recording medium in which an anti-warpage layer is formed on a rear surface of the optical recording medium is, for example, proposed in Japanese Patent Publication 4-195745 so as to minimize the warpage occurring in the optical recording medium.

The optical recording medium disclosed in JP-A-4-195745 has a first dielectric layer formed on a surface of a substrate, and a second dielectric layer formed on a rear surface of the substrate and having the same coefficient of thermal expansion as that of the first dielectric layer. According to the optical recording medium disclosed in JP-A-4-195745, a stress or a bending moment occurred in the first dielectric layer is cancelled off by a stress or a bending moment occurred in the second dielectric layer so that stresses applied to the surface and the rear surface of the substrate are balanced each other, thereby preventing the warpage from occurring in the optical recording medium.

However, in recent years, next-generation optical recording media which have larger capacity and higher data transmission rate are proposed. In these optical recording media, the numerical aperture (NA) of an objective lens for focusing the laser beam is made higher and the wavelength λ of the laser beam is made shorter so that the beam spot diameter of the laser beam used for recording and reproducing data is made extremely short, thereby trying to enhance recording density.

However, when the numerical aperture NA of the objective lens for focusing the laser beam increases, as can be seen from Expression 1 below, a problem occurs in that a tolerable angle error in the tilt of an optical axis of the laser beam with respect to the optical recording medium, that is, a tilt margin T extremely decreases.

$$T ∝ \frac{λ}{d \cdot {NA}^{3}} \qquad [ Expression 1 ]$$

Referring to Expression 1, “d” denotes the distance from an optical incident surface to a surface of an information layer on which data are recorded, that is, the thickness of a layer through which the laser beam is transmitted. As can be clearly seen from Expression 1, the tilt margin T decreases as NA of the objective lens becomes higher and increases as the thickness d of the layer through which the laser beam is transmitted becomes smaller.

Accordingly, in the next-generation optical recording medium, a resin layer having a thickness of 30 to 200 μm is formed on an information layer and a laser beam is irradiated from the side of the resin layer so that data are recorded and reproduced, which decrease the thickness d of the layer through which the laser beam is transmitted, thereby attempting to increase the tilt margin.

This is why the next-generation type optical recording medium, has an asymmetrical structure in which an information layer and a resin layer is sequentially laminated on a supporting substrate having a thickness of about 1.1 mm and two disk- shaped substrates having a thickness of 0.6 mm are adhered to each other with the information layer being interposed therebetween, unlike the DVD type optical recording medium having a symmetrical structure.

Accordingly, in the next-generation type optical recording medium, since the thickness of the resin layer is different from that of the supporting substrate, a warpage is apt to occur on the optical recording medium due to a change in temperature or the like, and in particular, when the supporting substrate is formed of a material different from that of the resin layer, properties such as a rigidity, a coefficient of linear expansion, a Young's modulus, an internal stress of a material used for forming the resin layer are different from those of a material used for forming the supporting substrate. Therefore the warpage is more apt to occur on the optical recording medium due to a change in temperature or the like.

However, when a large warpage occurs in the next-generation type optical recording medium, it also becomes difficult to read recorded data similarly to the existing optical recording medium. Therefore it is strongly required to minimize the warpage on the optical recording medium.

Accordingly, even in the next-generation type optical recording medium, it is considered that a resin layer having almost the same property as the property of a resin layer formed on a surface of the supporting substrate be formed on a rear surface of the supporting substrate, and a stress applied to the surface of the supporting substrate be canceled off by a stress applied to the rear surface of the supporting substrate, thereby capable of minimizing the warpage occurring on the optical recording medium.

However, in order to form the resin layer having almost the same property on the rear surface of the supporting substrate, it is required to carry out a spin-coating process again by inverting the supporting substrate after carrying out the spin-coating process to form the resin layer. Furthermore, generally, a label surface is formed on the rear side of the optical recording medium so as to indicate the type of the optical recording medium or the information stored in the optical recording medium or carry out a decorative design, which causes a manufacturing process to be complicated, which results in cost-up.

Further, it is possible to suppress the warpage occurring on the optical recording medium by forming the resin layer with a resin film having almost the same property as that of the supporting substrate on the surface of the supporting substrate instead of forming the resin layer on the rear surface of the supporting substrate, but such a resin film is expensive and manufacturing facility needs to be added for the resin film, which is not preferable because it causes more cost-up.

### SUMMARY OF THE INVENTION

Accordingly, an object to the present invention is to provide an optical recording medium capable of minimizing the warpage while preventing the cost-up.

In order to achieve the above-mentioned object, the present invention provides a supporting substrate, which includes:first and second resin layers each having a thickness of 30 to 200 μm, and having the supporting substrate interposed therebetween. In this case, a laser beam is irradiated through the first resin layer, and the second resin layer contains a filler and is formed by a screen printing method.

According to a research of the present inventor, when the thixotropy of a UV curable resin for forming the second resin layer by containing a filler in the second resin layer is enhanced, it has been found that a UV curable coat film having an excellent surface property and a uniform layer thickness can be formed by a screen printing method. Therefore, according to the present invention, the second resin layer having the excellent surface property and the uniform layer thickness can be formed by a screen printing method.

As such, in the present invention, since the second resin layer can be formed by a screen printing method the second resin layer and a label layer to be formed on the second resin layer can be sequentially formed by a single screen printing apparatus, which makes it possible to skip the procedure of carrying in and out the supporting substrate with respect to a spin coating apparatus in forming the second resin layer and the label layer, which can lead to a simplified manufacturing process.

Furthermore, when the second resin layer is formed by the screen printing method, it is possible to reduce the use amount of the UV curable resin by extruding the UV curable resin from the screen printing plate to form a coat film made of the UV curable resin as compared to the spin coating method which develops UV curable resin using a centrifugal force to form a coat film made of the UV curable resin.

Therefore, according to the present invention, the manufacturing process can be simplified and the use amount of the UV curable resin can be reduced while two resin layers can be formed on a surface and a rear surface of the supporting substrate, which makes it possible to prevent the cost-up while minimizing the warpage on the optical recording medium.

In the present invention, the second resin layer is preferably formed of an ultraviolet curable resin containing a filler, and the property of the ultraviolet curable resin containing the filler after curing the ultraviolet curable resin is preferably same as the property of the first resin layer.

In this case, the UV curable resin having the same property as that of the first resin layer after curing the UV curable resin means one in which at least a Young's modulus and a coefficient of linear expansion among properties including a rigidity, a coefficient of linear expansion, an internal stress are different from those of the first resin layer within a range of 5% in the present specification.

When the second resin layer is formed of the UV curable resin having the same property as that of the first resin layer after curing the UV curable resin, it is possible to form two resin layers having the same property as each other on both surfaces of the supporting substrate, thereby capable of more effectively suppressing the warpage from occurring on the optical recording medium.

In the present invention, the ultraviolet curable resin containing the filler preferably has a thixotropic index (TI) of 1.2 to 1.8 when a thixotropy is defined using the TI.

In the present specification, the TI is defined by a value measured using a B type viscometer manufactured by TOKYO KEIKI KABUSHIKIKAISHA, and it is given by η₂ᵣₚₘ/η₂₀ᵣₚₘ. In this case, η₂ᵣₚₘ the viscosity of the UV curable resin measured when the number of revolutions of the spindle of the B type viscometer is set to 2 rpm, and η₂₀ᵣₚₘ is the viscosity of the UV curable resin measured when the number of revolutions of the spindle of the B type viscometer is set to 20 rpm.

Further, in the present invention, the content of the filler which is added to the second resin layer is preferably 5 to 30% by weight, and more preferably 10 to 20% by weight. If the content of the filler to be added to the second resin layer is less than 5% by weight, the thixotropy of the UV curable resin for forming the second resin layer may not sufficiently increase. On the other hand, if the content of the filler exceeds 30% by weight, the ratio of the UV curable resin in the second resin layer decreases, so that the curing property is degraded, which in turn causes a cured region and a non-cured region to be mixed in the second resin layer so that a surface of the second resin layer may be tacky or the second resin layer may be brittle.

Further, the particle diameter of the filler contained in the second resin layer is preferably 1 to 50 μm and more preferably 1 to 10 μm. If the particle diameter of the filler contained in the second resin layer is less than 1 μm, the thixotropy of the UV curable resin for forming the second resin layer may not sufficiently increase. On the other hand, if the particle diameter of the filler exceeds 50 μm, the screen printing plate may be clogged. In a portion where the screen printing plate is clogged, only the UV curable resin except the filler is extruded from the screen printing plate, so that the amount of the filler remaining on the screen printing plate increases when the clogging of the screen printing plate increases as the printing is repeated. Accordingly, when the number of printing increases, the amount of filler contained in the UV curable resin on the screen printing plate increases, which causes the viscosity of the UV curable resin to be excessively higher. As a result, the screen printing plate often needs to be cleaned to thereby degrade the productivity.

In the present invention, the second resin layer is preferably formed by means of a screen printing method using a screen printing plate of a metal mask or a screen printing plate having a double mesh structure. When such a screen printing plate is used, a thick second resin layer having a thickness of 30 to 200 μm can be formed using the screen printing method as desired.

In a preferred embodiment of the present invention, a laser beam having a wavelength of 380 to 450 nm is irradiated through the first resin layer to read or reproduce data.

According to the present invention, it is possible to provide an optical recording medium capable of preventing the cost-up while minimizing the warpage.

### BRIEF DESCRIPTION OF THE DRAWINGS

FIG. 1 is a schematic perspective view of an optical recording medium manufactured by a method of manufacturing an optical recording medium according to a preferred embodiment of the present invention.

FIG. 2 is an enlarged schematic cross-sectional view of a portion denoted by A in FIG. 1.

FIG. 3 is a flow chart illustrating a manufacturing routine of an optical recording medium according to a preferred embodiment of the present invention.

FIG. 4 is a process view illustrating a process of manufacturing an optical recording medium.

FIG. 5 is a process view illustrating a process of manufacturing an optical recording medium.

FIG. 6 is a schematic plan view illustrating the structure of a screen printing apparatus according to a preferred embodiment of the present invention.

FIG. 7 is a schematic cross-sectional view illustrating the structure of a screen printing section according to a preferred embodiment of the present invention.

### DETAILED DESCRIPTION OF THE PREFERRED EMOBDIMENTS

Hereinafter, preferred embodiments of the present invention will be described in detail with reference to the accompanying drawings.

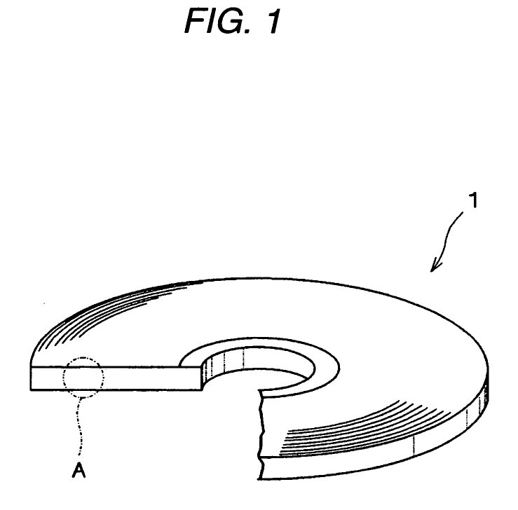

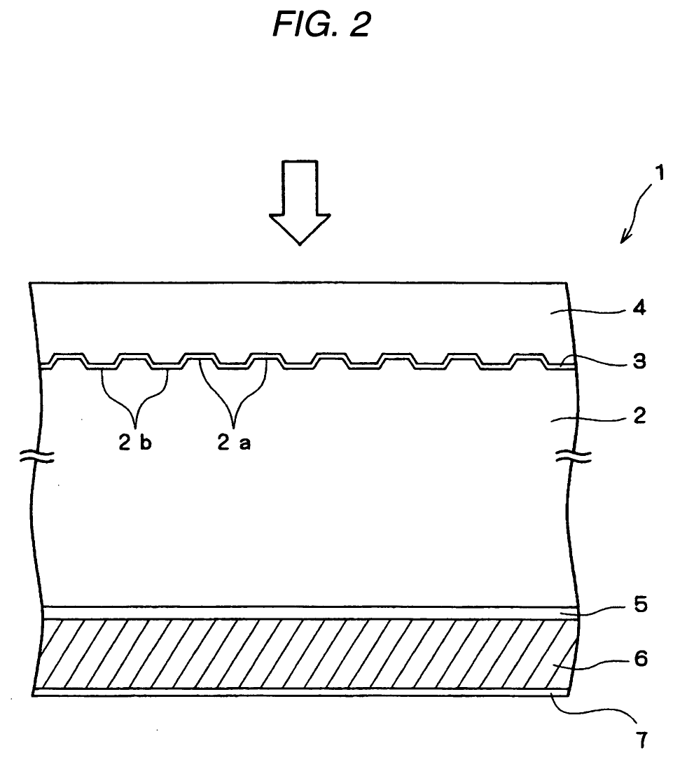

FIG. 1 is a schematic perspective view of an optical recording medium 1 manufactured by a method of manufacturing an optical recording medium according to a preferred embodiment of the present invention, and FIG. 2 is an enlarged schematic cross- sectional view of a portion denoted by A in FIG. 1.

As shown in FIG. 1, an optical recording medium 1 is disk-shaped, and has a center hole for setting the optical recording medium 1 in a recording and reproducing apparatus formed in its center portion. Further, the optical recording medium 1 is configured such that a laser beam having a wavelength of 380 to 450 nm is irradiated from a direction denoted by arrows in FIG. 2 through an objective lens (not shown) having a numerical aperture NA satisfying λ/NA≦640 nm to record and reproduce data.

As can be seen from FIG. 2, the optical recording medium 1 includes a supporting substrate 2, an information layer 3 formed on a surface of the supporting substrate 2, a first resin layer 4 formed on the information layer 3, a moisture-proof layer 5 formed on a rear surface of the supporting substrate 2, a second resin layer 6 formed on the moisture-proof layer 5, and a label layer 7 formed on the second resin layer 6.

The supporting substrate 2 functions as a support member of the optical recording medium 1, and the information layer 3 is a layer on which data is to be recorded. The first resin layer 4 is a layer to transmit the laser beam, and the moisture-proof layer 5 acts to prevent the moisture from penetrating from the external side of the optical recording medium 1 into the supporting substrate 2. The second resin layer 6 has a function of acting as an anti-warpage layer, and minimizes the warpage occurring on the optical recording medium 1 by canceling off a stress or a bending moment occurring on the first resin layer 4 with a stress or a bending moment occurring on the second resin layer 6. The label layer 7 is a layer for displaying a kind of the optical recording medium 1 or information stored in the optical recording medium 1, or a layer for carrying out a decorative design.

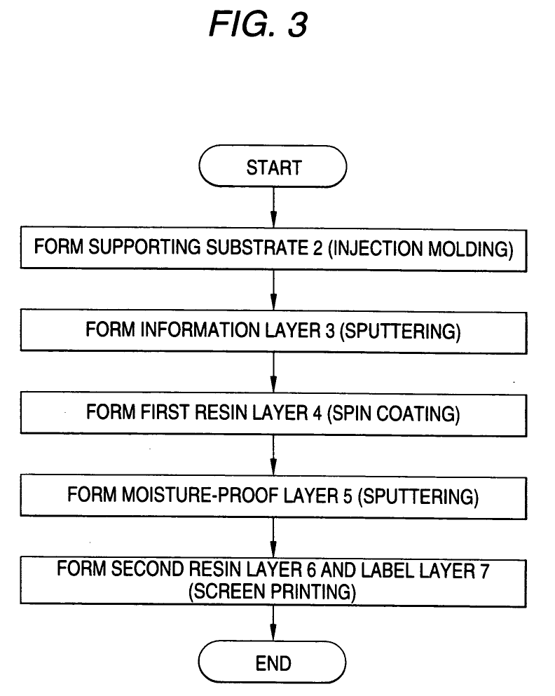

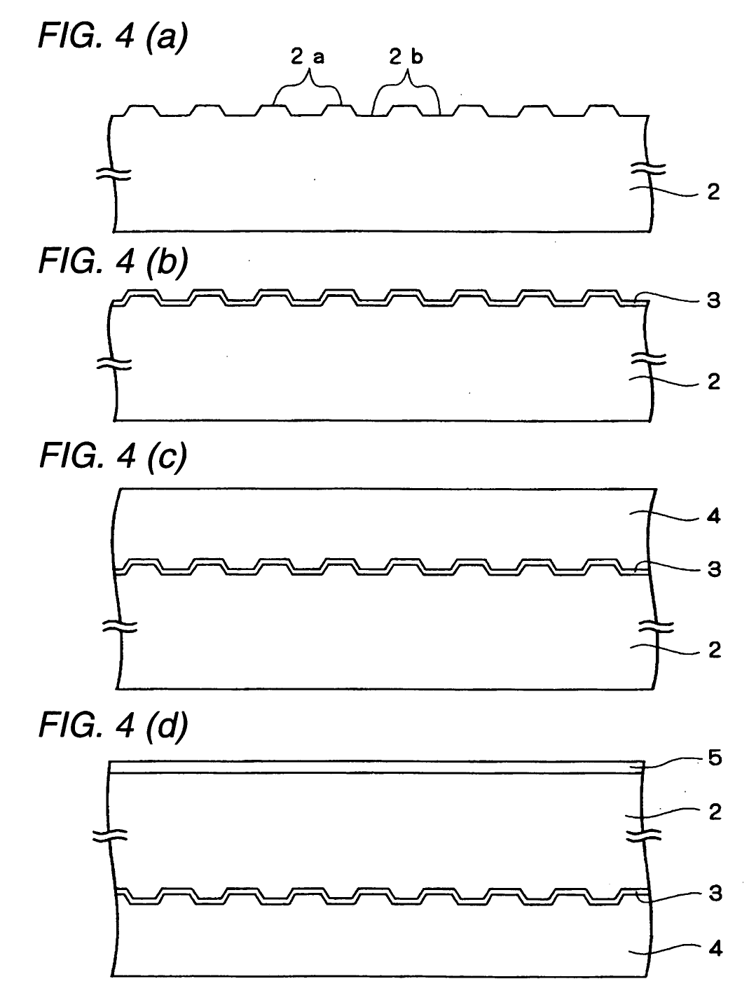

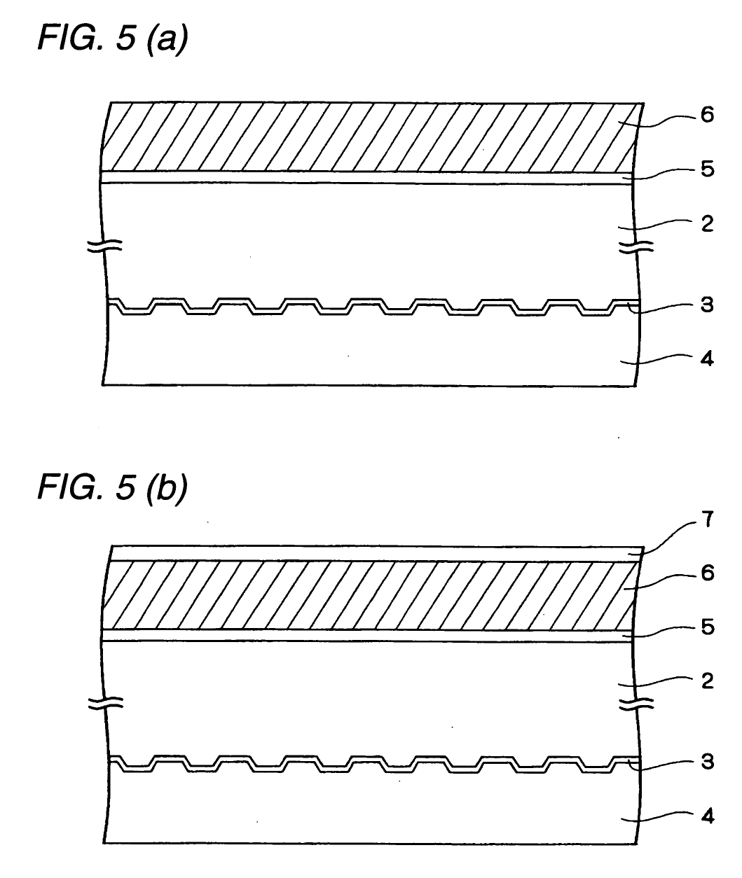

The optical recording medium 1 having the above-described structure is manufactured by the following description. FIG. 3 is a flow chart illustrating a routine of manufacturing the optical recording medium 1 according to a preferred embodiment of the present invention, and FIGS. 4(a) to 4(d) and FIGS. 5(a) and 5(b) are process views illustrating a method of manufacturing the optical recording medium 1.

First, as shown in FIG. 4(a), a supporting substrate 2 having grooves 2a and lands 2b on its surface is formed by means of injection molding using a stamper.

A material for forming the supporting substrate 2 is not particularly limited as long as it can function as a support member of the optical recording medium 1, for example, a polycarbonate resin or olefin resin may be employed for the same.

The thickness of the supporting substrate 2 is not particularly limited, but it is preferable to form the supporting substrate with a thickness of about 1.1 mm.

The grooves 2a and/or the lands 2b function as guide tracks of the laser beam when data are to be recorded on the information layer 3.

Subsequently, as shown in FIG. 4(b), an information layer 3 is formed on an almost entire surface of the supporting substrate 2 in which the grooves 2a and the lands 2b are formed.

In the present embodiment, the information layer 3 is not particularly limited, but it can be formed including a recordable recording layer containing an organic pigment such as a cyanine-based pigment, a porphyrin-based pigment as a main component, or including a phase-change type recording layer containing a phase-change material such as Ge—Sb—Te, In—Sb—Te as a main component.

Further, the information layer 3 does not need to be configured only with the recording layer, but may be formed with another layer such as a dielectric layer or a reflective layer on a surface, a rear surface, or both surfaces of the recording layer if necessary.

The information layer 3 is preferably formed with a thickness of 20 to 300 nm, more preferably with a thickness of 50 to 200 nm.

Subsequently, the supporting substrate 2 in which the information 3 is formed is set on a spin coating apparatus, and then a first resin layer 4 is formed on the information 3 by means of a spin coating method as shown in FIG. 4(c).

The first resin layer 4 is required to have an optical transparency, a less optical absorption or reflectance in a wavelength range of the laser beam to be used, that is, a range of 380 to 450 nm, and a less birefringence, so that it is, for example, formed of a UV curable resin.

A resin composition used for forming the first resin layer 4 includes a photopolymerization monomer, a photopolymerization oligomer and a photoinitiator, and other additives if necessary. A monomer having a molecular weight less than 2000 is suitable for the photopolymerization monomer, for example, monofunctional (metha) acrylate, multifunctional (metha)acrylate or the like may be employed for the same. Further, an oligomer in which a radical crosslinked or polymerized by UV irradiation with acrylic double bond, allylic double bond, unsaturated double bond is contained or introduced within molecules, may be suitable for the photopolymerization oligomer. Furthermore, any of well-known ones in the art may be employed as the photoinitiator, for example, molecular cleavage type photopolymerization initiator may be employed for the same.

In the present embodiment, the first resin layer 4 is formed with a thickness of 30 to 200 μm.

When the first resin layer 4 is formed on the information layer 3, the supporting substrate 2 in which the information layer 3 and the first resin layer 4 are formed is vertically inverted by 180 degrees, and it is set on a sputtering apparatus so as to have a rear surface of the supporting substrate 2 positioned upward, so that a moisture-proof layer 5 is formed on the rear surface of the supporting substrate 2 by means of a sputtering method as shown in FIG. 4(d).

In the present embodiment, a material for forming the moisture-proof layer 5 is not particularly limited as long as it can prevent moisture from penetrating into the supporting substrate 2, and it is preferable to form the moisture-proof layer 5 by using a dielectric material that contains at least one kind of metal selected from a group consisting of Si, Zn, Al, Ta, Ti, Co, Zr, Pb, Ag, Sn, Ca, Ce, V, Cu, Fe, Mg, B, and Ba, or oxide, nitride, sulfide, fluoride containing these metals, or a mixture thereof.

The moisture-proof layer 5 is preferably formed with a thickness of 20 to 300 nm, and more preferably with a thickness of 30 to 200 nm.

When the moisture-proof layer 5 is formed, the supporting substrate 2 is then set on a screen printing section, and a second resin layer 6 is formed on a surface of the moisture-proof layer 5 by means of a screen printing method as shown in FIG. 5(a).

The second resin layer 6 is formed with a thickness of 30 to 200 μm as is same as the first resin layer 4. However, the second resin layer 6 is not necessarily formed with the same thickness as that of the first resin layer 4, but may be formed with a thickness different from that of the first resin layer 4 as long as the property of the second resin layer is not significantly different from that of the first resin layer 4 and the thickness is in a range capable of minimizing the warpage of the optical recording medium 1.

In the present embodiment, since the properties of the second resin layer 6 including a rigidity, a coefficient of linear expansion, a Young's modulus, and an internal stress are preferably same as those of the first resin layer 4, the UV curable resin having the same property after curing the second resin layer as that of the first resin layer is used as the resin material for forming the second resin layer 6. The UV curable resin for forming the second resin layer 6 is not necessarily same as the UV curable resin for forming the first resin layer 4 as long as the property after curing the second resin layer is same as that of the first resin layer 4.

Further, in the case of forming the second resin layer 6 by means of the screen printing method, if the viscosity of the UV curable resin is too low, it becomes difficult to form a coat film made of a UV curable resin having a thickness of 30 to 200 μm, and the UV curable resin may be misaligned out of a screen printing plate. On the contrary, if the viscosity of the UV curable resin is too high, it may not be extruded from the screen printing plate as desired. This is why the UV curable resin for forming the second resin layer 6 has a viscosity of 3000 to 10000 mPa·s in an environment of 25° C. in the present embodiment.

However, in the case of forming the second resin layer 6 using the screen printing method, even when the UV curable resin for forming the second resin layer 6 has a viscosity of 3000 to 10000 mPa·s in an environment of 25° C., the surface smoothness of a coat film made of the UV curable resin may be damaged or the thickness of the coat film made of the UV curable resin may be nonuniform. As a result, the second resin layer 6 may not sufficiently function as an anti-warpage layer, which in turn may fail to a balance between a stress applied to a surface and a stress applied to a rear surface of the supporting substrate 2 so that the warpage may not be suppressed from occurring on the optical recording medium 1. Further, since the label layer 7 is formed on the second resin layer 6 to cause the surface shape of the second resin layer 6 to affect the outer shape of the label layer 7, from this point of view, it is necessary to form the second resin layer 6 so as to make the unevenness of the surface smaller.

Accordingly, in the present embodiment, a filler is contained in the UV curable resin for forming the second resin layer 6 for the purpose of enhancing the thixotropy of the UV curable resin concerned.

According to researches of the present inventor, it has been found that the second resin layer 6 having an excellent surface property and a uniform layer thickness can be formed by a screen printing method when the thixotropy of the UV curable resin increases by containing a filler in the UV curable resin for forming the second resin layer 6.

In the present embodiment, the ultraviolet curable resin containing the filler preferably has a thixotropic index (TI) of 1.2 to 1.8 when the thixotropy is defined using the TI.

In the present embodiment, an inorganic filler such as silica, alumina, talc, barium sulfate, calcium carbonate, titanium oxide, a plastic powder such as polyethylene, polypropylene, styrene, silicon resin, or an organic filler such as protein powder may be employed as the filler contained in the second resin layer 6. Since the label layer 7 is formed on a surface of the second resin layer 6, it is not preferable to add a dull white color to the second resin layer 6, and in consideration of this, it is preferable to employ silica, alumina, or talc among the above-described fillers, which is relatively transparent.

Further, the content of the filler which is added to the second resin layer 6 is preferably 5 to 30% by weight, and more preferably 10 to 20% by weight. If the content of the filler to be added to the second resin layer 6 is less than 5% by weight, the thixotropy of the UV curable resin for forming the second resin layer 6 may not sufficiently increase. In the meantime, if the content of the filler exceeds 30% by weight, the ratio of the UV curable resin in the second resin layer 6 decreases. Therefore, the curing property is degraded, which in turn causes a cured region and a non-cured region to be mixed in the second resin layer 6, so that a surface of the second resin layer 6 may be tacky or the second resin layer 6 may be brittle.

Further, the diameter of the filler contained in the second resin layer 6 is preferably 1 to 50 m and more preferably 1 to 10 μm. When the diameter of the filler contained in the second resin layer 6 is less than 1 μm, the thixotropy of the UV curable resin for forming the second resin layer 6 may not sufficiently increase, and when the diameter of the filler exceeds 50 μm, the screen printing plate may be blocked. In a portion where the screen printing plate was blocked, only the UV curable resin except the filler is extruded from the screen printing plate, so that the amount of the filler remaining on the screen printing plate increases when the blocking of the screen printing plate increases as the printing is repeated. Accordingly, when the number of printing increases, the amount of filler contained in the UV curable resin on the screen printing plate increases, which causes the viscosity of the UV curable resin to be significantly higher, so that the screen printing plate often needs to be cleaned to thereby degrade the productivity.

When the second resin layer 6 is formed on the moisture-proof layer 5, the label layer 7 is then formed on the second resin layer 6.

The label layer 7 is formed by sequentially and separately coating each of the UV curable resins colored with different colors from each other on a portion of a surface or an entire surface of the second resin layer 6 using the screen printing method.

The thickness of the label layer 7 is different in response to a label to be formed, but the label layer 7 is very thin as compared to the second resin layer 6 and is typically formed with a thickness of 5 to 20 μm.

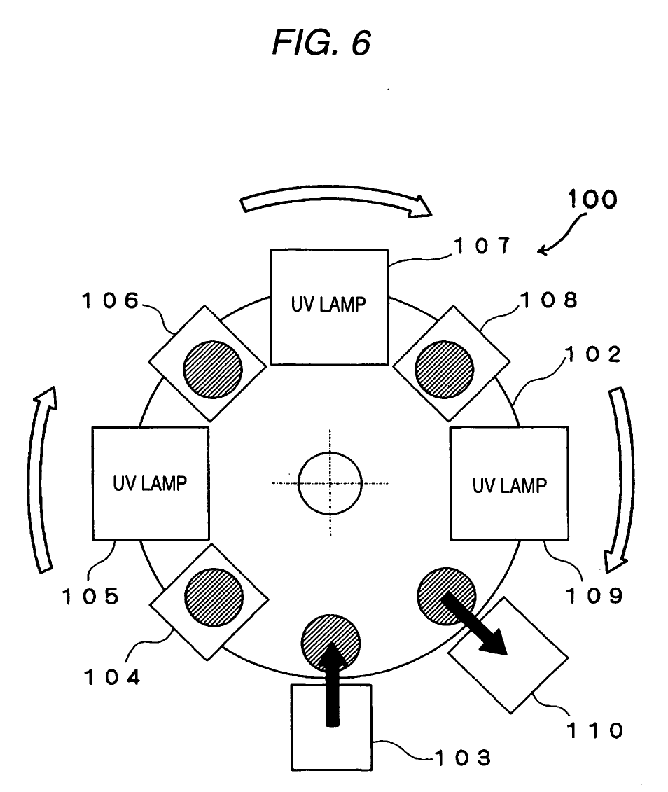

FIG. 6 is a schematic plan view illustrating the structure of the screen printing apparatus for forming the second resin layer 6 and the label layer 7.

As shown in FIG. 6, a screen printing apparatus 100 includes a turntable 102 which can be turned, a carrying-in loader 103 for carrying in the supporting substrate 2 on which the moisture-proof layer 5 is formed, a first screen printing section 104 for forming a coat film made of UV curable resin on a surface of the supporting substrate 2 on which the moisture-proof layer 5 is formed, a first UV lamp 105 for irradiating UV rays on the coat film made of the UV curable resin formed on the moisture-proof layer 5 to form a second resin layer 6, a second screen printing section 106 for forming a coat film made of UV curable resin colored with a first color on the second resin layer 6, a second UV lamp 107 for irradiating UV rays on the coat film made of UV curable resin formed on the second resin layer 6, a third screen printing section 108 for forming a coat film made of UV curable resin colored with a second color on the second resin layer 6, a third UV lamp 109 for irradiating UV rays on the coat film made of UV curable resin formed on the second resin layer 6 to form the label layer 7, and an carrying-out loader 110 for carrying out the supporting substrate 2 in which the label layer 7 is formed.

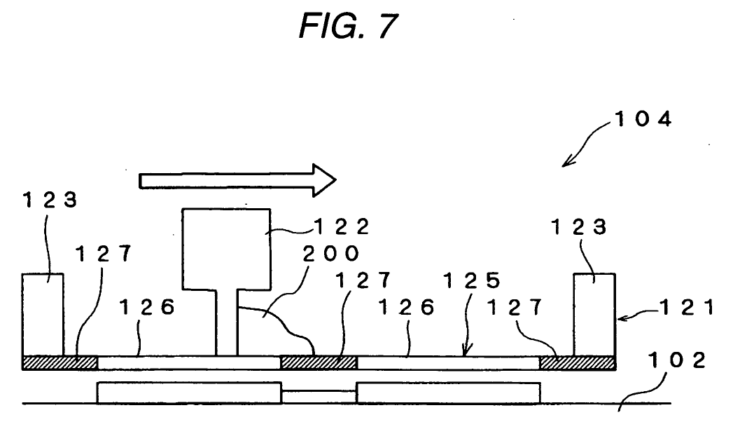

FIG. 7 is a schematic cross-sectional view illustrating the structure of the first screen printing section 104.

As shown in FIG. 7, the first screen printing section 104 includes a screen printing plate 121 disposed opposite to the turntable 102, and a squeegee 122 for extruding a UV curable resin 200 on the screen printing plate 121.

The screen printing plate 121 includes a plate frame 123 formed at a peripheral end of the screen printing plate 121, and a screen 125 tightly fixed to the plate frame 123 as shown in FIG. 7. The screen 125 has a double mesh structure that two sheets of stainless screen are formed with stainless metal lines which are knit together in a mesh shape. In order to form a coat film of resin with a thickness of 30 to 200 μm by means of a screen printing method, it is preferable for the screen 125 to have a discharge amount of 50 to 200 ml/m². A mask region 127 masked by an emulsion or the like, and a printing region 126 other than the mask region are formed in the screen 125.

When the second resin layer 6 and the label layer 7 are formed by using the screen printing apparatus 100 with the above-described structure, the supporting substrate 2 in which the moisture-proof layer 5 is formed is first carried in by the carrying-in loader 103, and is set on the turntable 102. The turntable 102 then rotates along the direction of an arrow, to move the supporting substrate 2, on which the moisture-proof layer 5 is formed, to the first screen printing section 104.

When the supporting substrate 2 in which the moisture-proof layer 5 is formed is moved to the first screen printing section 104, the squeegee 122 slides from one end to the other end of the screen printing plate 121 while pressing the surface of the screen 125. As a result, the UV curable resin 200 containing the filler is extruded from the printing region 126 of the screen 125, thereby forming a coat film made of UV curable resin with a thickness of 30 to 200 μm.

In the present embodiment, the thixotropy of the UV curable resin increases because of the filler contained in the UV curable resin, so that the UV curable resin is pressed by the squeegee 122 when it is extruded from the screen 125, which causes the viscosity to temporarily decrease to increase the liquidity. As a result, the UV curable resin is uniformly spread on the moisture-proof layer 5, thereby forming a coat film made of UV curable resin with a uniform thickness. After the UV curable resin is coated on the moisture-proof layer 5 and is fixed, a surface of the coat film made of the UV curable resin is made smooth during a period of recovering its original viscosity from the decreased viscosity, so that the unevenness of the surface of the coat film made of the UV curable resin formed when extruded from the screen 125 decreases.

When a coat film made of UV curable resin is formed on the moisture-proof layer 5, the turntable 102 rotates, to move the supporting substrate 2, on which the coat film made of the UV curable resin is formed, downward from the first UV lamp 105.

Subsequently, a shutter for covering the first UV lamp 105 is opened. The first UV lamp 105 is already turned on, and allows UV rays to be irradiated on the UV curable resin by opening the shutter. By doing so, the coat film made of the UV curable resin is cured, thereby forming the second resin layer 6. In the present embodiment, as described above, an unevenness formed on the coat film of the UV curable resin can be reduced while the thickness of the coat film can be made uniform, so that the second resin layer 6 having an excellent surface property and a uniform layer thickness can be formed. Accordingly, the second resin layer 6 for minimizing the warpage on the optical recording medium 1 can be formed by means of the screen printing method.

When the second resin layer 6 is formed, the turntable 102 rotates to move the supporting substrate 2, on which the second resin layer 6 is formed, to the second screen printing section 106.

Subsequently, a UV curable resin colored with a first color is prepared on the screen printing plate of the second screen printing section 106 and is extruded by the squeegee, so that a coat film of the UV curable resin for forming a label is formed on a portion of a surface or an entire surface of the second resin layer 6.

When the coat film of the UV curable resin colored with the first color is formed, the turntable 102 rotates to move the supporting substrate 2, on which the coat film of the UV curable resin colored with the first color is formed, downward from the second UV lamp 107. A shutter of the second UV lamp 107 is then opened and UV rays are irradiated therefrom so that the coat film of the UV curable resin colored with the first color is cured, thereby forming a first colored layer for forming the label layer 7.

When the first colored layer is formed, the turntable 102 rotates to move the supporting substrate 2 having the first colored layer formed thereon to the third screen printing section 108.

Subsequently, a UV curable resin colored with a second color different from the first color is prepared on the screen printing plate of the third screen printing section 108 and is extruded by the squeegee, so that a coat film of the UV curable resin colored with the second color is formed on a portion of a surface or an entire surface of the second resin layer 6.

When the coat film of the UV curable resin colored with the second color is formed, the turntable 102 rotates to move the supporting substrate 2, on which the coat film of the UV curable resin colored with the second color is formed, downward from the third UV lamp 109. A shutter of the third UV lamp 109 is then opened and UV rays are irradiated therefrom so that the coat film of the UV curable resin colored with the second color is cured, thereby forming the second colored layer for forming the label layer 7. By doing so, the label layer 7 is formed, completing formation of the optical recording medium 1.

When the formation of the optical recording medium 1 is completed, the turntable 102 rotates to move the optical recording medium 1 to the carrying-out loader 110. The optical recording medium 1 moved to the carrying-out loader 110 is carried out of the screen printing apparatus 100 to be received in a stocker (not shown).

As described above, in the present embodiment, a filler is contained in the UV curable resin for forming the second resin layer 6 to increase the thixotropy of the UV curable resin, which makes it possible to form a coat film made of the UV curable resin having an excellent surface property and a uniform layer thickness by means of the screen printing method. Accordingly, it is possible to form the second resin layer 6 having an excellent surface property and a uniform layer thickness by means of the screen printing method.

As such, in the present embodiment, the second resin layer 6 can be formed by the screen printing method, so that the second resin layer 6 and the label layer 7 can be sequentially formed by a single screen printing apparatus. Accordingly, it is possible to skip the procedure of carrying in and out the supporting substrate 2 with respect to the spin coating apparatus in forming the second resin layer 2 and the label layer 7, which can lead to a simplified manufacturing process.

Furthermore, when the second resin layer 6 is formed by the screen printing method, it is possible to reduce the use amount of the UV curable resin by extruding the UV curable resin 200 on the screen 125 by the squeegee 122 so as to form a coat film made of UV curable resin as compared to the spin coating method which develops the UV curable resin using a centrifugal force so as to form a coat film made of UV curable resin by coating the UV curable resin on an entire surface of the moisture-proof layer 5.

Therefore, in the present embodiment, the manufacturing process can be simplified and the use amount of the UV curable resin can be reduced while two resin layers can be formed on a surface and a rear surface of the supporting substrate 2, thereby capable of preventing the cost-up while minimizing the warpage of the optical recording medium 1.

### EXAMPLES

Hereinafter, examples will be described for clarity of effects of the present invention.

### First Example

Sample 1 was manufactured in the following way.

First, a disk-shaped polycarbonate substrate having a thickness of 1.1 mm and an outer diameter of 120 mm was manufactured by means of injection molding.

Subsequently, an information layer was formed on a surface of the polycarbonate substrate by a sputtering method.

Subsequently, a UV curable resin A having the composition below was prepared.

[UV curable resin A]
urethane acrylate (NEGAMI CHEMICAL INDUSTRIAL Co. Ltd.:PRODUCT NAME ‘ART RESIN UN-5200’) . . . 50% by weight
trimethyllolpropantriacrylate (NIPPON KAYAKU KABUSIKIKAISHA: PRODUCT NAME ‘KARAYAD TMPTA’) . . . 33% by weight
phenoxy hydroxy propyl acrylate (NIPPON KAYAKU KABUSHIKIKAISHA: PRODUCT NAME ‘KARAYAD R-128’) . . . 14% by weight 1-hydroxy cyclo hexyl phenyl ketone (NIPPON CHIBAGAIGI
KABUSHIKIKAISHA: PRODUCT NAME ‘IRG184’) . . . 3% by weight

Furthermore, the viscosity of the UV curable resin A was measured using the B type viscometer manufactured by TOKYO KEIKI KABUSHIKIKAISHA. The viscosity of the UV curable resin A was 4200 mPa·s in an environment of 25° C.

Subsequently, the polycarbonate substrate on which a reflective layer have been formed was set on the spin coating apparatus, and the above-described UV curable resin A was coated on the information layer, thereby forming a coat film. The coat film was then irradiated with the integrated amount of light of 1000 mJ/cm² to cure the UV curable resin, thereby forming the first resin layer having a thickness of 100 μm.

Subsequently, the UV curable resin containing a filler was prepared in a ratio disclosed below.
UV curable resin A . . . 95% by weight
Silica (manufactured by SCM Chemical: product name ‘G-100’; average particle diameter 3.7 μm) . . . 5% by weight

Subsequently, the viscosity of the UV curable resin containing silica was measured by using the above-described B type viscometer. The viscosity of the UV curable resin containing the silica was 4200 mPa·s in an environment of 25° C.

Furthermore, the number of revolutions of the spindle of the above-described B type viscometer was sequentially set to 2 rpm and 20 rpm, thereby measuring the respective viscosities of η₂ᵣₚₘ and η₂₀ᵣₚₘ. The viscosity η₂ᵣₚₘ was then divided by η₂₀ᵣₚₘ to obtain the TI. The TI of the UV curable resin containing silica was 1.28.

Subsequently, the polycarbonate substrate on which the first resin layer have been formed was vertically inverted by 180 degrees and then was set on the screen printing section, and the UV curable resin containing silica was coated on the polycarbonate substrate, thereby forming a coat film.

When a coat film made of the UV curable resin is formed on the polycarbonate substrate by a screen printing method, a double mesh type screen plate was employed in which two sheets of stainless screen ST80 (PRODUCT NAME) manufactured by TOKYO PROCESS SERVICE KABUSIKIKAISHA and having an opening width of 268 μm, a thickness of 95 to 100 μm, and a discharge amount of 71.0 ml/m² overlapped each other.

After the coat film made of UV curable resin was formed on the polycarbonate substrate, and the surface property of the coat film made of the UV curable resin was evaluated. In evaluating the surface property, it was determined by visual inspection whether a large unevenness was formed on a surface of the formed coat film and whether a bubble was formed within the coat film. If any of the unevenness and the bubble was not present, ‘GOOD’ was given, and if any one of them was present, ‘BAD’ was given. As a result of evaluation, its surface property was ‘GOOD’.

Subsequently, the coat film was irradiated with an integrated amount of light of 1000 mJ/cm² to cure the UV curable resin, thereby forming a second resin layer having a thickness of 75 μm.

By doing so, Sample 1 was manufactured.

After Sample 1 was formed, the curing property of the second resin layer of Sample 1 was evaluated. In evaluating the curing property, it was evaluated by means of palpation whether a surface of the second resin layer was tacky, and the absence of the tackiness corresponded to ‘GOOD’ and the presence of the tackiness corresponds to ‘BAD’. As a result of evaluation, the curing property of the second resin layer of Sample 1 was ‘GOOD’.

Subsequently, Samples 2 to 7 were sequentially manufactured as was done with Sample 1 except that each ratio containing silica and UV curable resin was changed as shown in Table 1. When Samples 2 to 7 were manufactured, as was done with Sample 1, the viscosity and TI of the UV curable resin containing silica were measured. The measured results are shown in Table 1 below.

TABLE 1

| | Ultraviolet | | | |
|---|---|---|---|---|
| | curable resin A | Silica | Viscosity | |
| | (% by weight) | (% by weight) | (mPa · s) | TI |
| Sample 1 | 95 | 5 | 4200 | 1.28 |
| Sample 2 | 90 | 10 | 4570 | 1.33 |
| Sample 3 | 80 | 20 | 5680 | 1.50 |
| Sample 4 | 70 | 30 | 7200 | 1.80 |
| Sample 5 | 60 | 40 | 10050 | 2.05 |
| Sample 6 | 50 | 50 | 14800 | 2.20 |
| Sample 7 | 100 | 0 | 4200 | 1.00 |

Further, when Samples 2 to 7 were manufactured, as was done with Sample 1, a coat film made of UV curable resin was formed on a polycarbonate substrate by a screen printing method, and the surface property of the UV curable resin was evaluated after the coat film was cured to form a second resin layer, and the curing property of the second resin layer was evaluated. The evaluated results are shown in Table 2.

Subsequently, Samples 1 to 7 were left until their temperature became stable in an environment of 25° C., and then each sample was set on a high-accuracy laser apparatus of measuring the warpage angle manufactured by KEYNCE KABUSHIKIKAISHA (product name: LA-2000), and the warpage angle (β₂₅) was measured at a position of 58 mm from a center of each sample.

Furthermore, Samples 1 to 7 were left until their temperature became stable in an environment of 55° C., and then each sample was set on the above-described high-accuracy laser apparatus of measuring the warpage angle, and the warpage angle (β₅₅) was measured at a position of 58 mm from a center of each sample.

Subsequently, a difference between the warpage angle (β₅₅) at 55° C. and the warpage angle (β₂₅) at 25° C. was obtained per each sample. The results are shown in Table 2 below.

TABLE 2

| | SAMPLE No. | | | | | | |
|---|---|---|---|---|---|---|---|
| | 1 | 2 | 3 | 4 | 5 | 6 | 7 |
| Surface property | GOOD | GOOD | GOOD | GOOD | GOOD | BAD | BAD |
| Curing property | GOOD | GOOD | GOOD | GOOD | BAD | BAD | GOOD |
| Warpage angle | 0.20 | 0.22 | 0.23 | 0.27 | 0.31 | 0.34 | 0.18 |
| difference (deg) | | | | | | | |

As shown in Table 2, in Samples 1 to 4 having a TI in a range of 1.2 to 1.8, all had the excellent surface property, and a difference between the warpage angle (β₅₅) at 55° C. and the warpage angle (β₂₅) at 25° C. was 0.30 degrees or less, so that it was observed that it is possible to suppress the warpage from occurring in the optical recording medium. On the contrary, in Samples 5 and 6 having a TI other than a range of 1.2 to 1.8, the surface property was not good, and the difference (β₅₅−β₂₅) exceeded 0.30 degrees. Further, in Sample 7 in which silica is not contained, it was determined that the difference (β₅₅−β₂₅) was 0.3 degrees or less, however, its surface property was not good.

### Example 2

Sample 8 was manufactured as below.

First, an information layer was formed on a surface of a polycarbonate substrate having a thickness of 1.1 mm by a sputtering method.

Subsequently, a UV curable resin B having the composition below was prepared.

[UV Curable Resin B]
urethane acrylate (NEGAMI KABUSHIKIKAISHA: PRODUCT NAME ‘ART RESIN UN-2500’) . . . 45% by weight
tripropylene glycol diacrylate (OSAKA ORGANIC KABUSHIKIKAISA: PRODUCT NAME ‘BISCOAT 310’) . . . 40% by weight iso desyl acrylate (SARTOMER COMPANY, Inc.: PRODUCT NAME ‘SR-395’) . . . 12% by weight
1-hydroxycyclohexylphenylketone (NIPPON CHIBAGAIGI KABUSHIKIKAISHA: PRODUCT NAME ‘IRG184’) . . . 3% by weight

Furthermore, the viscosity of the UV curable resin in which alumina was contained was measured using the above-described B type viscometer. The viscosity of the UV curable resin was 3800 mpa·s in an environment of 25° C.

Subsequently, a polycarbonate substrate in which a reflective layer was formed was set on a spin-coating apparatus and the UV curable resin B was coated on the information layer by a spin-coating method to form a coat film. The coat film was then irradiated with the UV rays having an integrated amount of light of 1000 mJ/cm² to cure the UV curable resin, forming the first resin layer having a thickness of 100 μm.

Subsequently, the UV curable resin in which the filler was contained was prepared with the ratio shown below.
UV curable resin B . . . 95% by weight
alumina (SHOWA DENKO KABUSHIKIKAISHA: PRODUCT NAME ‘UA-5605’ (average particle diameter 3.0 μm) . . . 5% by weight

Subsequently, a TI was obtained while measuring the viscosity of the UV curable resin in which alumina was contained using the above-described B type viscometer. The viscosity of the UV curable resin containing alumina was 3850 mPa·s and the TI was 1.23 in an environment of 25° C.

Subsequently, a polycarbonate substrate on which a first resin layer was formed was vertically inverted by 180° and then set in the screen printing section, and UV curable resin containing alumina was coated on the polycarbonate substrate by using the same screen as that used in Example 1, thereby forming a coat film.

After a coat film of UV curable resin was formed on a polycarbonate substrate, as was done in Example 1, the surface property of the coat film of the UV curable resin was evaluated. The surface property of the coat film of the UV curable resin containing alumina was ‘GOOD’.

Subsequently, the coat film was irradiated with UV rays having an integrated amount of light of 1000 mJ/cm², curing the UV curable resin, so that a resin layer having a thickness of 75 μm was formed. By doing this, Sample 8 was manufactured.

After Sample 8 was manufactured, as was done in Example 1, the curing property of the second resin layer of Sample 8 was evaluated. As a result of the evaluation, the curing property of the second resin layer of Sample 8 was ‘GOOD’.

Subsequently, Samples 9 to 14 were sequentially manufactured as was done with Sample 8 except that each ratio containing alumina and UV curable resin was changed as shown in Table 3. When Samples 9 to 14 were manufactured, as was done with Sample 8, the viscosity and TI of the UV curable resin containing alumina were measured. The measured results are shown in Table 3.

TABLE 3

| | UV curable | | | |
|---|---|---|---|---|
| | resin B | Alumina | Viscosity | |
| | (% by weight) | (% by weight) | (mPa · s) | TI |
| Sample 8 | 95 | 5 | 3850 | 1.23 |
| Sample 9 | 90 | 10 | 4050 | 1.30 |
| Sample 10 | 80 | 20 | 4830 | 1.45 |
| Sample 11 | 70 | 30 | 6950 | 1.67 |
| Sample 12 | 60 | 40 | 9800 | 1.86 |
| Sample 13 | 50 | 50 | 14200 | 2.01 |
| Sample 14 | 100 | 0 | 3800 | 1.00 |

Further, when Samples 9 to 14 were manufactured, as was done with Sample 8, a coat film of UV curable resin was formed on the polycarbonate substrate by a screen printing method, and the surface property of the coat film of the UV curable resin was evaluated while the coat film was cured to form a second resin layer, and the curing property of the second resin layer was evaluated. The evaluated results are shown in Table 4 below.

Subsequently, each of Samples 8 to 14 was left in an environment of 25° C. until the temperature of the samples became stable, and each of the samples was set on the above-described high-accuracy laser apparatus of measuring the warpage angle, so that the warpage angle (β₅₅) was measured at a position of 58 mm from a center of each sample.

Furthermore, each of Samples 8 to 14 was left in an environment of 55° C. until the temperature of the samples became stable, and each of the samples was set on the above- described high-accuracy laser apparatus of measuring the warpage angle, so that the warpage angle (β₅₅) was measured at a position of 58 mm from a center of each sample in the same manner.

Subsequently, a difference between a warpage angle (β₅₅) at 55° C. and a warpage angle (β₂₅) at 25° C. in the respective samples was calculated. The results are shown in Table 4 below.

TABLE 4

| | SAMPLE No. | | | | | | |
|---|---|---|---|---|---|---|---|
| | 8 | 9 | 10 | 11 | 12 | 13 | 14 |
| Surface property | GOOD | GOOD | GOOD | GOOD | GOOD | BAD | BAD |
| Curing property | GOOD | GOOD | GOOD | GOOD | BAD | BAD | GOOD |
| Warpage angle | 0.19 | 0.21 | 0.25 | 0.29 | 0.35 | 0.38 | 0.18 |
| difference (deg) | | | | | | | |

As is shown in Table 4, in Samples 8 to 11 having a TI in a range of 1.2 to 1.8, all had an excellent surface property, and a difference (β₅₅−β₂₅) between the warpage angle (β₅₅) at 55° C. and the warpage angle (β₂₅) at 25° C. was 0.30 degrees or less, so that it is possible to suppress the warpage from occurring in the optical recording medium. On the contrary, in Samples 12 and 13 having a TI other than a range of 1.2 to 1.8, the surface property was not good and the difference (β₅₅−β₂₅) of the warpage angle exceeded 0.30 degrees. Further, in Sample 14 in which alumina is not contained, the difference (β₅₅−β₂₅) of the warpage angle is 0.30 deg or less, but it was determined that the surface property was not good.

It is understood that the present invention is not limited to the above-described embodiments and examples, and various changes can be made within a scope of the present invention as set forth in the appended claims which are also included within the scope of the present invention.

For example, the optical recording medium 1 according to the present embodiment shown in FIGS. 1 and 2 is one in which the write-once or phase-change-type information layer 3 is formed on the supporting substrate 2, but the optical recording medium of the present invention is not limited thereto, and a reproduction-dedicated optical recording medium may be employed in which pits are formed on a surface of the supporting substrate 2 and data are constituted with such pits.

Further, in the process of manufacturing the optical recording medium according to the present embodiment shown in FIG. 7, a coating film of UV curable resin is formed by the screen printing plate 121 having the stainless screen 125, but it does not necessarily need to using the screen printing plate 121 having the stainless screen 125 as long as a coating film of UV curable resin having a thickness of 30 to 200 μm can be formed, and the coating film of the UV curable resin may be formed using a screen printing plate having a screen knit with flexible resin fibers such as polyester in a mesh shape or a metal screen of a metal mask with mechanical-resistant and chemical-resistant properties together with flexibility in a thickness direction.

Furthermore, in the process of manufacturing the optical recording medium according to the present embodiment shown in FIG. 7, the screen 125 is comprised of a screen having a double mesh structure in which two sheets of screen overlap each other, but the screen for forming the second resin layer 6 does not necessarily need to have the double mesh structure and can have only one sheet of screen.

1. An optical recording medium comprising:
a supporting substrate;
a first resin layer formed on a front surface the supporting substrate and having a thickness of 30 to 200 μm, a laser beam to be irradiated through the first resin layer; and
a second resin layer formed on a rear surface of the supporting substrate and having a thickness of 30 to 200 μm,
wherein the second resin layer contains a filler and is formed by a screen printing method.

2. The optical recording medium according to claim 1, wherein the second resin layer is formed of an ultraviolet curable resin containing a filler, and the property of the ultraviolet curable resin containing the filler after curing the ultraviolet curable resin is same as the property of the first resin layer.

3. The optical recording medium according to claim 1, wherein the ultraviolet curable resin containing the filler has a thixotropic index (TI) of 1.2 to 1.8.

4. The optical recording medium according to claim 1, wherein a filler of 5 to 30% by weight is contained in the second resin layer.

5. The optical recording medium according to claim 1, wherein a filler having an average particle diameter of 1 to 50 μm is contained in the second resin layer.

6. An optical recording medium comprising:
a supporting substrate;
an information layer formed on a surface of the supporting substrate;
a first resin layer formed on the information layer and having a thickness of 30 to 200 μm;
a moisture-proof layer formed on a rear surface of the supporting substrate 2;
a second resin layer formed on the moisture-proof layer and having a thickness of 30 to 200 μm; and
a label layer formed on the second resin layer,
wherein second resin layer contains a filler and is formed by a screen printing method.
